(19) United States
(12) Patent Application Publication
(10) Pub. No.: US 2015/0265924 A1
(43) Pub. Date: Sep. 24, 2015

(54) MATCH-BASED REMOVAL OF GAME BOARD HAZARDS

(71) Applicant: Big Fish Games, Inc., Seattle, WA (US)

(72) Inventors: Christopher Campbell, Seattle, WA (US); Brian Thompson, Bainbridge Island, WA (US); Sean Richer, Bellevue, WA (US); Hamzah Kasom Osman, Seattle, WA (US); Peter Yiap, Des Moines, WA (US)

(73) Assignee: Big Fish Games, Inc., Seattle, WA (US)

(21) Appl. No.: 14/223,684

(22) Filed: Mar. 24, 2014

(51) Int. Cl. A63F 13/537

(52) U.S. Cl. CPC A63F 13/537

(57) ABSTRACT

A game board associated with a game and that includes one or more tiles and one or more hazards may be presented to a user. The user may select or match one or more tiles, which may cause a hazard in close proximity to the one or more tiles and the selected one or more tiles to be removed from the game board. During gameplay, the user may cause the game board to be filled, thereby causing additional tiles and/or hazards to be introduced onto the game board. The game board may include different types of hazards, in which a particular type of hazard may be removed from the game board by the user selecting particular types of tiles.

### RELATED APPLICATIONS

This Applicant is related to U.S. patent application Ser. No. ______, entitled “Match-Based Hazard Removal and Game Board Filling”, to Campbell, et al., and U.S. patent application Ser. No. ______, entitled “User-Initiated Filling of Game Board”, to Campbell, et al.

### BACKGROUND

With the growing popularity of casual gaming, consumers are able to play various types of games utilizing different mediums, including computing devices, tablet devices, mobile telephones, etc. Examples of casual games include puzzle games, hidden object games, word and trivia games, card games, board games, and Mahjong games. In some games, game players typically attempt to achieve an objective via a game board, which is filled automatically as the game player progresses through the game board. Many of these games are based on luck, as opposed to a strategy employed by the game player.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including one or more users, one or more user devices, one or more networks, and one or more content servers that may provide access to games to be played by the one or more users.

FIG. 2 is a diagram showing an example game board associated with a game that includes an objective, one or more hazards, and one or more tiles.

FIG. 3 is a diagram showing an example content server that provides user access to a game that includes a game board that is presented to the users.

FIG. 4 is a diagram showing an example game board that depicts the matching of tiles and the removal of hazards that reside on the game board.

FIG. 5 is a diagram showing an example game board that depicts a user-initiated fill of the game board.

FIG. 6 is a flow diagram showing an example process of user-selection of tiles and removal of corresponding hazards on a game board.

FIG. 7 is a flow diagram showing an example process of a user-initiated fill of a game board.

FIG. 8 is a flow diagram showing an example process of competitive and collaborative game play with respect to a game board.

FIG. 9 is a flow diagram showing an example process of adjusting the difficulty of a game board based on one or more user actions.

### DETAILED DESCRIPTION

This disclosure describes systems and/or processes for providing access to one or more games that are played via a game board, where the game board may include an objective, one or more hazards, and one or more tiles. More particularly, a user playing the game may select sets of tiles on the game board for the purpose of removing the hazards and obtaining the objective. For the purposes of this discussion, the games described above and set forth in additional detail below may include physical games and games that are played online, such as games played via a network (e.g., the Internet) and games that are downloaded to, or are accessible by, a user device.

In various embodiments, the hazards may be any tile, icon, etc., that prevents, obstructs, or otherwise hinders a user from progressing through the game and/or the game board. A user may cause the hazards to be removed from the game board by selecting sets of tiles, which may include selecting matching sets of tiles that are adjacent, or are in close proximity, to one of the hazards. Furthermore, the removal of a certain hazard may be triggered by the user matching two or more tiles of a particular type. For instance, provided that the hazard is associated with “fire”, the user may have to match two or more “water” tiles that are in close proximity to the “fire” tile in order to remove that hazard. In some embodiments, the hazards and/or the tiles may be modified during gameplay. That is, while the user is playing the game via the game board, various tiles or hazards may be dynamically added, removed and/or modified, which may affect the difficulty of the game.

As the user progresses through the game by matching sets of tiles and removing hazards as a result, the tiles and/or the hazards may be removed from the game board. In existing games, if an object is removed from a game board, the game board will then be automatically filled with additional objects so that the game board remains filled with objects. Here, however, the user may control whether the game board is filled with additional tiles or hazards, such as by providing user input that corresponds to filling the game board (i.e., actuating a “fill” button or mechanism). Therefore, the user may fill the game board in a strategic manner, based on his/her own discretion and based on a number of times in which the user is allowed to fill the game board.

Moreover, the systems and/or processes described therein may dynamically adjust the difficulty of the game board during game play. For instance, while a user is playing the game via the game board, and possibly based on one or more actions taken by the user or a behavior of the user, the game board may be modified. For example, one or more tiles or hazards may be added or removed from the game board. Alternatively, or in addition, the tiles or hazards may be modified, such as by changing a first hazard into a second hazard, moving a hazard to a different location on the game board, causing a hazard to grow, multiply or spawn additional hazards, causing a hazard to consume tiles, and so on. Therefore, as the game board is modified in real-time (or near real-time), the difficulty of the game board may increase/decrease, which may cause the user to dynamically adjust his/her strategy with respect to the game.

In further embodiments, multiple users may play the game and/or access the game board at the same time, thus creating a social aspect to the game. That is, upon a particular condition being satisfied, the systems and/or processes described herein may allow multiple users to play the game via the game board. For instance, multiple players may access the game board, or a different game board, and compete against one another. In other embodiments, multiple users may play the game in a collaborative manner, such as by the multiple players sequentially taking turns making moves/selections on the game board for the purpose of achieving a common goal (e.g., accessing or removing an objective tile). One or more of the multiple users may also collaborate for the purpose of agreeing on moves/selections to be made via the game board. As a result, in addition to a single user playing the game via the game board, multiple users may play the game utilizing the game board in a competitive and/or a collaborative manner.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Example Environment

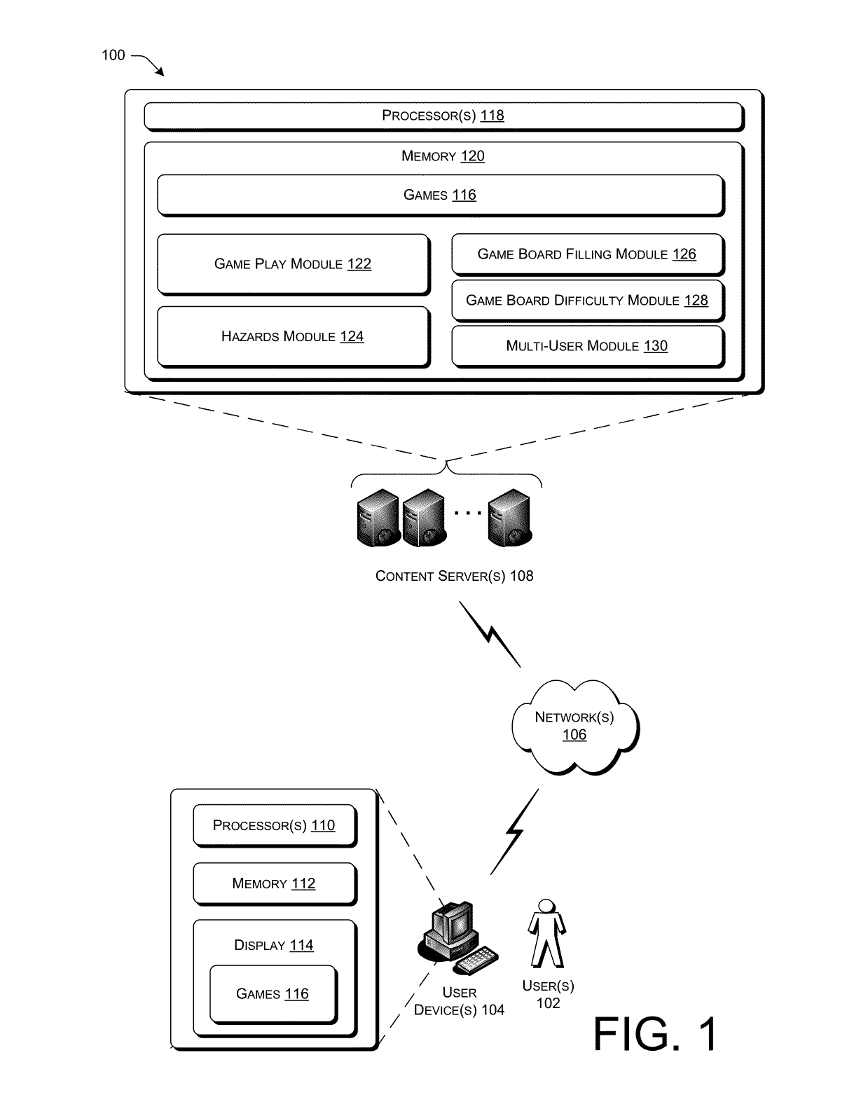

FIG. 1 illustrates an architecture 100 in which a user 102 may electronically or physically access games 116 (e.g., software games 116, casual games 116, physical games 116, games 116 played for real or virtual currency, games 116 of chance, etc.) and play those games 116, such as via a user device 104. As described below, the user device 104 may be implemented in any number of ways, such as a computer, a laptop computer, a tablet device, a personal digital assistant (PDA), a gaming console, a multi-functioning communication device, and so on. The user 102 may access the games 116 over a network 106, such as the Internet, which may be communicatively coupled to one or more content server(s) 108. The content server(s) 108 may store various types of the games 116, such as software games, and other content that is accessible by the user device 104 (e.g., media content, audio content, video content, etc.). For instance, the user 102 may access and/or play the games 116 via one or more sites (e.g., a website) that are accessible via the network(s) 106 and/or via an application associated with the user device 104. One or more processor(s) 110, a memory 112, and a display 114 of the user device 104 may enable the user 102 to access and/or play the games 116. In addition to the games 116 being stored on, and/or accessed via, the content server(s) 108, the games 116 may also be stored directly on the user device 104.

Furthermore, one or more processor(s) 118 and a memory 120 of the content server(s) 108 may allow the content server(s) 108 to enable the users 102 to play the games 116. More particularly, a game play module 122, a hazards module 124, a game board filling module 126, a game board difficulty module 128 and a multi-user module 130 are stored in memory 120 and executed by the processor(s) 118 to enable the user 102 to access one or more game boards for the purpose of playing the game(s) 116.

For the purposes of this discussion, the games 116 may include physical games and the games 116 that may be played online or via a user device 104. Moreover, the games 116 may be played for real currency (e.g., U.S. dollars) or virtual currency (e.g., chips, tokens, points, etc.). The games 116 may also relate to games of chance or casual gaming, which may include physical games, online games that may be played over the network(s) 106, and/or software games that may be stored on, and/or be accessible by, the user device 104.

Games of chance may refer to games in which the outcome is at least partly random or is influenced at least in part by a randomizing device. In games of chance, the players may elect to wager real or virtual currency, or anything of monetary value, prior to at least a portion of the game being played. Examples of games of chance may include physical games, games played via a network 106, or games played via a user device 104, such as dice games, spinning tops, playing cards, slot machines, roulette wheels, and many other casino games. A game of chance may have some skill element, although the chance or randomness of the game may play a greater role in determining the outcome of the game. In other games of chance, a certain degree of skill may enhance a player's performance with respect to the game. This may be the case where the player(s) make game decisions based upon previous or incomplete knowledge, such as in various casino or card games (e.g., blackjack, poker, etc.).

On the other hand, casual games may include games (e.g., video games) that are associated with any type of gameplay and any type of genre. Casual games may have a set of simple rules that allow a large audience to play, such as games that may be played utilizing a touch-sensitive display, a telephone keypad, a mouse having one or two buttons, etc. Moreover, casual games may not require a long-term commitment or unique skills to play the game, thus allowing users 102 to play the game in short time increments, to quickly reach a final stage of the game, and/or to continuously play the game without needing to save the game. Casual games may also be played on any medium, including personal computers, game consoles, mobile devices, etc., and may be played online via a web browser. Casual games may be referred to as “casual” since the games may be directed towards consumers who can come across the game and get into gameplay in a short amount of time, if not immediately. Examples of casual games may include puzzle games, hidden object games, adventure games, strategy games, matching games, arcade and action games, word and trivia games, casino games, and/or card and board games.

Other games may first be downloaded to and/or installed on the user device 104 and/or an application associated with the user device 104. These games, and the physical games, the games of chance, and the casual games described above, may also be acquired by the user 102. Regardless of whether the games 116 are stored on the user device 104 or the content server(s) 108, playing the games 116 may include accessing, viewing, trying, and/or otherwise interacting with the games 116.

The users 102 may access the games 116 in any of a number of different manners. For instance, the users 102 may play the games 116 in a physical setting (e.g., physical slot machines, a physical game board). The users 102 may also access a site (e.g., a website) associated with an entity, such as a merchant or service provider, that provides access to the games 116. Such a site may be remote from the user device 104 but may allow the users 102 to interact with the games 116 via the network(s) 106. Moreover, the users 102 may download one or more applications to the user device 104 in order to access the games 116. In this case, the content server(s) 108 may provide, transmit, suggest, and/or recommend the games 116 to the user device 104, whereby the users 102 may interact with the games 116 via the downloaded application(s). In other embodiments, the games 116 may be streamed from the content server(s) 108 to the user device 104 such that the users 102 may interact with the games 116 in real-time. Once the user 102 accesses the games 116, the users 102 may perform a variety of actions, including learning about the games 116, viewing the games 116, trying the games 116, acquiring (e.g., purchasing, renting, leasing, etc.) the games 116, downloading/installing the games 116 to the user device 104, and/or playing the games 116.

Additionally, the users 102 may have a user account associated with the entity that provides and/or provides access to the games 116. For instance, assuming that the games 116 are available via a website, each of the users 102 may have a user account that specifies various types of information relating to the users 102. This information may include personal information, user preferences, and/or some user identifier (ID), which may be some combination of characters (e.g., name, number, etc.) that uniquely identifies the user 102 from other users 102.

In some embodiments, the user device 104 may be any type of device that is capable of receiving, accessing, playing, and/or otherwise interacting with the games 116, such as, for example, a personal computer, a laptop computer, a cellular telephone, a personal digital assistant (PDA), a tablet device, an electronic book (e-Book) reader device, a television, or any other device that may be used to access games 116 that may be viewed, tried, played, downloaded, installed, and/or acquired by the user 102. For instance, the user 102 may utilize the user device 104 to access and navigate between one or more sites, such as web sites, web pages related thereto, and/or documents or content associated with those websites or web pages that may be of interest to the user 102. For instance, the user 102 may utilize the user device 104 to access sites to view, play, and/or download the games 116. Further, the user device 104 shown in FIG. 1 is only one example of a user device 104 and is not intended to suggest any limitation as to the scope of use or functionality of any user device 104 utilized to perform the processes and/or procedures described herein. Although the games 116 may be played via the user device 104, certain games 116 may be played without the use of a user device 104. For example, various physical games, casual games (e.g., matching games) and/or games of chance (e.g., slot machines, table top games, etc.) may be played in a physical setting without use of such user devices 104.

The processor(s) 110 of the user device 104 may execute one or more modules and/or processes to cause the user device 104 to perform a variety of functions, as set forth above and explained in further detail in the following disclosure. In some embodiments, the processor(s) 110 may include a central processing unit (CPU), a graphics processing unit (GPU), both CPU and GPU, or other processing units or components known in the art. For instance, the processor(s) 110 may allow the user device 104 to access sites associated with games 116 and/or download applications that are used to access and/or play the games 116. Additionally, each of the processor(s) 110 may possess its own local memory, which also may store program modules, program data, and/or one or more operating systems.

In at least one configuration, the memory 112 of the user device 104 may include any component that may be used to access, play, and/or download the games 116. Depending on the exact configuration and type of the user device 104, the memory 112 may also include volatile memory (such as RAM), non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 114 and other output device(s), such as speakers, a printer, etc. The user 102 may utilize the foregoing features to interact with the user device 104 and/or the content server 108 via the network(s) 106. More particularly, the display 114 of the user device 104 may include any type of display known in the art that is configured to present (e.g., display) information to the user 102. For instance, the display 114 may be a screen or user interface that allows the user 102 to access, play, and/or download the games 116. Further, one or more local program modules may be utilized to play the games 116 on a browser. The local program modules may be stored in the memory 112 and/or executed on the processor(s) 110 in order to present graphics associated with the games 116 on the display 114.

In some embodiments, the network(s) 106 may be any type of network known in the art, such as the Internet. Moreover, the user device 104 and the content server(s) 108 may communicatively couple to the network(s) 106 in any manner, such as by a wired or wireless connection. The network(s) 106 may also facilitate communication between the user device 104 and the content server(s) 108, and also may allow for the transfer of data or communications therebetween. For instance, the content server(s) 108 and/or other entities may provide access to the games 116 that may be accessed, played, and/or downloaded utilizing the user device 104.

In addition, and as mentioned previously, the content server(s) 108 may include one or more processor(s) 118 and a memory 120, which may include the game play module 122, the hazards module 124, the game board filling module 126, the game board difficulty module 128 and the multi-user module 130. The content server(s) 108 may also include additional components not listed above that perform any function associated with the content server(s) 108. In various embodiments, the content server(s) 108 may be any type of server, such as a network-accessible server, or the content server(s) 108 may be any entity that provides access to the games 116 that is stored on and/or is accessible by the content server(s) 108.

In various embodiments, the game play module 122 may enable one or more users 102 to play one or more of the games 116. In particular, the game play module 122 may allow multiple users 102 to play one of the games 116 in a virtual or physical environment. At least one of the games 116 may be played via a game board, which may represent a playing surface in which the game 116 is played. As stated above, the game board may include an objective, one or more tiles and/or one or more hazards. The user 102 may play the game 116 by matching at least two of the tiles, which may cause the removal of one or more hazards that are in close proximity (e.g., adjacent to) the matched tiles. The user 102 may seek to remove tiles and hazards for the purpose of progressing towards, obtaining or achieving the objective. In various embodiments, the objective may correspond to reaching a particular icon/tile, reaching or passing a level associated with the game 116, or progressing towards a certain goal (e.g., awards, trophies, dollars, chips, prizes, points, etc.). In various embodiments, the game play module 122 may enforce one or more rules to allow or facilitate the foregoing actions.

Moreover, the hazards module 124 may cause hazards to be introduced, added, modified, and/or removed from the game board. In various embodiments, the hazards may obstruct or hinder progress through the game 116 and/or the game board. The hazards may be removed as a result of the user 102 matching sets of tiles (e.g., two or more tiles) that are in close proximity to (e.g., adjacent to) the hazards. In response to the user 102 matching a particular set of tiles, a hazard in close proximity to at least one of the matched tiles and/or the set of matched tiles may be removed from the game board. As a result, by matching tiles and removing a corresponding hazard, the user 102 may progress through the game board and move closer to the objective and/or completing the game board, such as by removing all of the hazards and/or completing the objective. As discussed in greater detail herein, both the tiles and the hazards may differ in many respects, and the user 102 may have to match particular tiles in order to remove a particular hazard.

The game board filling module 126 may fill the game board with tiles, hazards, etc., in response to a request, such as in response to a request of the user 102. More particularly, as the user 102 matches tiles and thereby causes the removal of hazards from the game board, the amount of tiles and hazards on the game board may decrease. In some embodiments, the game board may be automatically filled with additional tiles and/or hazards. However, the user 102 may not want to fill the game board at that time. As a result, the game board filling module 126 may allow the user 102 to fill the game board at his/her discretion. For instance, the user 102 may actuate a fill mechanism (e.g., a fill button) that causes additional tiles and/or hazards to fill the game board. The tiles/hazards may drop from the top of the game board, slide from either side of the game board, fill from the bottom of the game board, fill from a non-ninety degree angle, and/or in other ways (e.g., fill or appear from above or below the game board). Moreover, the number of tiles/hazards that are filled may or may not correspond to the number of tiles/hazards that were previously removed as a result of the user's 102 actions.

Moreover, the game board difficulty module 128 may adjust the difficulty of the game 116 and/or the game board during game play. In various embodiments, the game board difficulty module 128 may adjust the difficulty of the game 116 and/or the game board based at least on part on one or more actions taken by the user 102 that is playing the game 116. For instance, the game board difficulty module 128 may adjust the difficulty of the game board after certain achievements are reached, such as the user 102 passing a level, achieving a certain score, or reaching a particular threshold (e.g., a number of tiles or hazards removed). Further, the game board difficulty module 128 may adjust the difficulty of the game board by adding tiles or hazards to the game board. The game board difficulty module 128 may also modify and/or remove tiles or hazards that are currently located on the game board, or by modifying (e.g., increasing, decreasing, etc.) the number of times in which the user 102 may fill the game board. The manner in which the tiles and/or hazards are modified is discussed in additional detail herein.

In other embodiments, the multi-user module 130 may allow multiple users 102 to play the game 116 via the game board. More particularly, the multi-user module 130 may allow multiple users 102 to access the same game board that is being played by other users 102, although the game boards may differ with respect to the tiles, hazards, etc., that are displayed on those game boards. In certain embodiments, the multiple users 102 may play the game 116 in a competitive manner, such as two or more users 102 playing the game board against one another. Alternatively, or in addition, multiple users 102 may play the game board in collaboration with one another, such as the users 102 making the moves on the game board sequentially or alternately. As a result, the users 102 may seek to achieve a common goal or objective that is shared by multiple users 102.

### Example Game Board

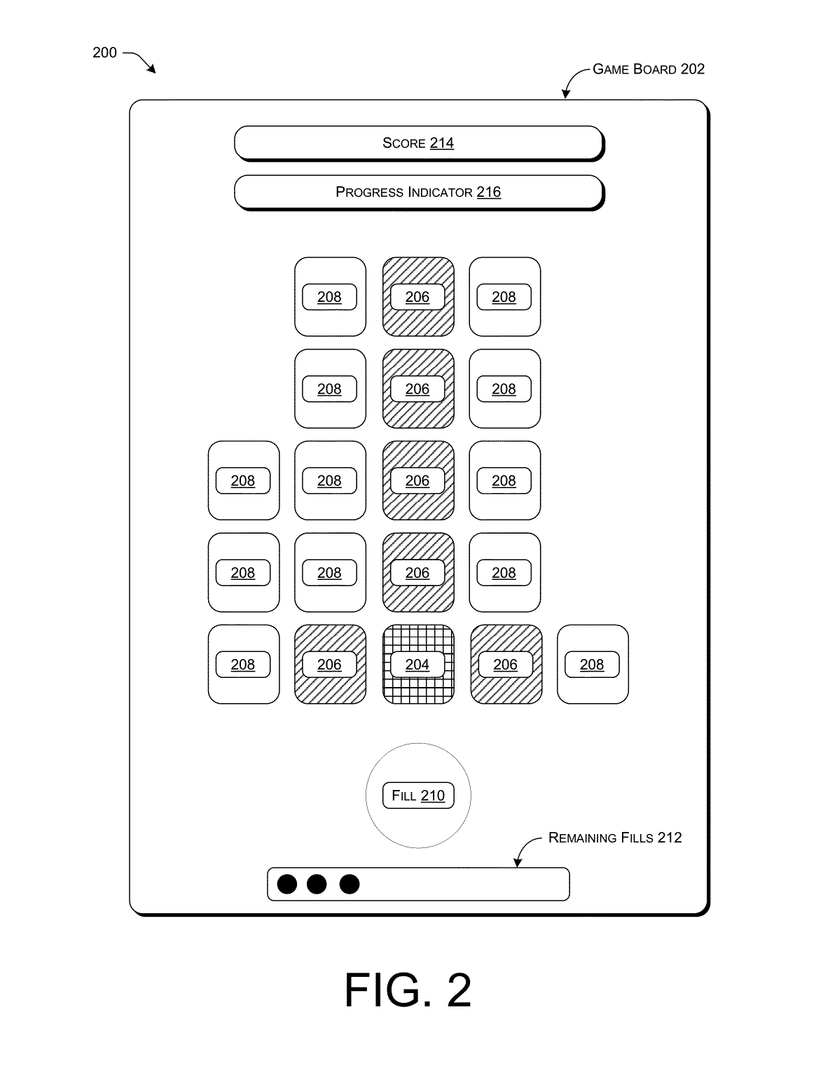

FIG. 2 illustrates an example diagram 200 that depicts a game board 202 that may be utilized with respect to a particular game 116. As stated above, a user 102 may access the game board 202 via a user device 104 for the purpose of playing the game 116. As shown, the game board 202 may include an objective 204, one or more hazards 206, one or more tiles 208, a fill 210 mechanism, a number of remaining fills 212, a score 214, and a progress indicator 216.

In various embodiments, the game board 202 may represent a physical or virtual surface or environment in which users 102 may play the game 116. Furthermore, the users 102 may make moves or take actions with respect to the game board 202 for the purpose of progressing through the game 116 towards a goal or an objective, such as objective 204. In order to achieve the objective 204, the user 102 may remove the hazards 206 by matching or selecting sets of one or more tiles 208. After at least some of the hazards 206 and/or the tiles 208 have been removed from the game board 202, the user 102 may cause additional hazards 206 and/or tiles 208 to be introduced on the game board 202 by actuating a fill 210 mechanism. Moreover, the number of times in which the user 102 may fill 210 the game board 202 may be limited, which may be represented by remaining fills 212. The remaining fills 212 may visually indicate the number of times the user 102 is allowed to fill the game board 202 with tiles 208 and/or hazards 206.

In response to matching tiles 208, removing hazards 206 and/or tiles 208 from the game board 202 and/or filling the game board 202 by actuating the fill 210 mechanism, the user 102 may maintain a score 214 for the game 116. Moreover, a progress indicator 216 may indicate an extent to which the user 102 has progressed through the game board 202 and/or progressed through the game 116 as a whole. After achieving a certain objective 204 or score 214, or by removing each of the hazards 206 residing on the game board 202, the user 102 may be presented with a new game board 202 of the game 116. That is, the user 102 may strategically match tiles 208 to achieve an objective 204 and/or to clear/remove one or more hazards 206, and the user 102 may strategically fill 210 the game board 202 at his/her discretion, as opposed to the game board 202 being filled automatically in response to tiles 208 being matched.

In various embodiments, the objective 204 of the game board 202 may be any goal or objective that is to be achieved or accomplished before the user 102 may advance to a new game board 202, level, game 116, and so on. For instance, the objective 204 may be any hazard 206 or tile 208 that the user 102 is to clear, remove, satisfy, reach, etc., in order to complete the game board 202. Using this example, the user 102 may need to match a certain amount of tiles 208 or remove a certain amount of hazards 206 that are in proximity to the objective 204. Furthermore, in order to satisfy the objective 204, the user 102 may have to match some or all of the tiles 208 or cause the removal of some or all of the hazards 206. In other embodiments, to achieve the objective 204, the user 102 may have to reach a certain score 214, accumulate a certain amount of points, or achieve some other criteria that measures the extent to which the user 102 is progressing through the game 116 and/or the game board 202.

Furthermore, the game board 202 may include one or more hazards 206 that may block, impede, hinder, or obstruct the user 102 from progressing through the game board 202 or from achieving/reaching the objective 204. One or more of the hazards 206 on the game board 202 may be the same, or one or more of the hazards 206 may be different. In various embodiments, the hazards 206 may be different with respect to size, shape, color, brightness, orientation, or in any other manner. Moreover, the hazards 206 may include various graphics, symbols, text, etc., that differentiates the hazards 206 from one another.

As stated above, the user 102 may match two or more tiles 208 by selecting those tiles 208. The tiles 208 may be selected via a mouse click, making contact with a touch-sensitive display that displays the game board 202, and so on. In response to the user 102 selecting two or more tiles 208, the matched tiles 208 and/or one or more hazards 206 that are in close proximity to at least one of the matched tiles 208 may be removed from the game board 202. For instance, by matching two or more tiles 208, one or more hazards 206 that are adjacent to (i.e., to the left or right of), that are above or below, or that are diagonal to one or more of the matched tiles 208 may be removed from the game board 202. If particular hazards 206 and/or tiles 208 are removed from the game board 202, those hazards 206/tiles 208 may disappear, fade away, move away in any direction, appear to break or explode, or may be removed in any manner that indicates to the user 102 that certain hazards 206/tiles 208 are being, or have been, removed (e.g., visual, audible, vibrations, etc.). By removing the hazards 206 and/or the tiles 208 from the game board 202, the user 102 may progress closer to the objective 204. In various embodiments, and as described in additional detail herein, the user 102 may have to match certain tiles 208 in order to remove or clear certain hazards 206.

As hazards 206 and/or tiles 208 are removed from the game board 202, the user 102 may fill 210 the game board 202 with additional hazards 206 and/or tiles 208. That is, by actuating the fill 210 mechanism, the user 102 may cause the game board 202 to be filled with additional hazards 206 and/or tiles 208. The additional hazards 206 and/or tiles 208 may be introduced to the game board 202 in any manner, such as by the hazards 206 and/or tiles 208 being added from any direction (e.g., top, bottom, sides, etc.), or appearing when the fill 210 mechanism is actuated. Furthermore, the user 102 may fill 210 the game board 202 at his/her discretion, as opposed to the game board 202 being filled automatically when hazards 206 and/or tiles 208 are removed from the game board 202.

In additional embodiments, although the user 102 may fill 210 the game board 202 an unlimited number of times, the user 102 may also be allowed to fill 210 the game board 202 a limited number of times while playing the game 116 or while interacting with a particular game board 202. The number of times the user 102 may fill 210 the game board 202 may be presented to the user 102, such as in a visual manner (e.g., images, video, etc.), in an audible manner (e.g., sound emitted from the user device 104), or in any other manner (e.g., vibrations). As shown in FIG. 2, the remaining fills 212 may indicate the number of times the user 102 may fill 210 the game board 202. Here, the three circles may indicate that the user 102 may fill 210 this game board 202, or multiple game boards 202, three more times. In response to the game board 202 being filled, additional hazards 206 and/or tiles 208 may appear, which may allow the user 102 to match additional tiles 208, remove additional hazards 206/tiles 208, improve the score 214, progress through the game 116 and/or the game board 202, and/or to achieve the objective 204.

As the user 102 is playing the game 116 via the game board 202, the user's 102 score 214 may be presented to the user 102 (e.g., visually, audibly, etc.). The score 214 may indicate the extent to which the user 102 is progressing through the game 116 and/or the game board 202 and may be represented by numbers, letters, currency, tokens, symbols, graphics, etc. Moreover, the user 102 may add to his/her score 214 (i.e., earn points, tokens, medals, dollars, etc.) by matching tiles 208, removing hazards 206 and/or tiles 208, actuating the fill 210 mechanism, achieving the objective 204, completing the game board 202, and so on.

Furthermore, the progress indicator 216 may indicate an extent to which the user 102 has progressed through the game 116 and/or the game board 202. For instance, the progress indicator 216 may illustrate how much of the game 116 and/or the game board 202 the user 102 has completed, or how much of the game 116 and/or the game board 202 remains. More particularly, the progress indicator 216 may indicate the number of tiles 208 matched, the number of hazards 206 and/or tiles 208 removed, the number of consecutive matches of tiles 208 (i.e., combinations of tile 208 matches), and so on. Moreover, the game board 202 may have any configuration, and is not limited to the features (e.g., objective 204, hazards 206, tiles 208, etc.) illustrated in FIG. 2.

### Example Content Server

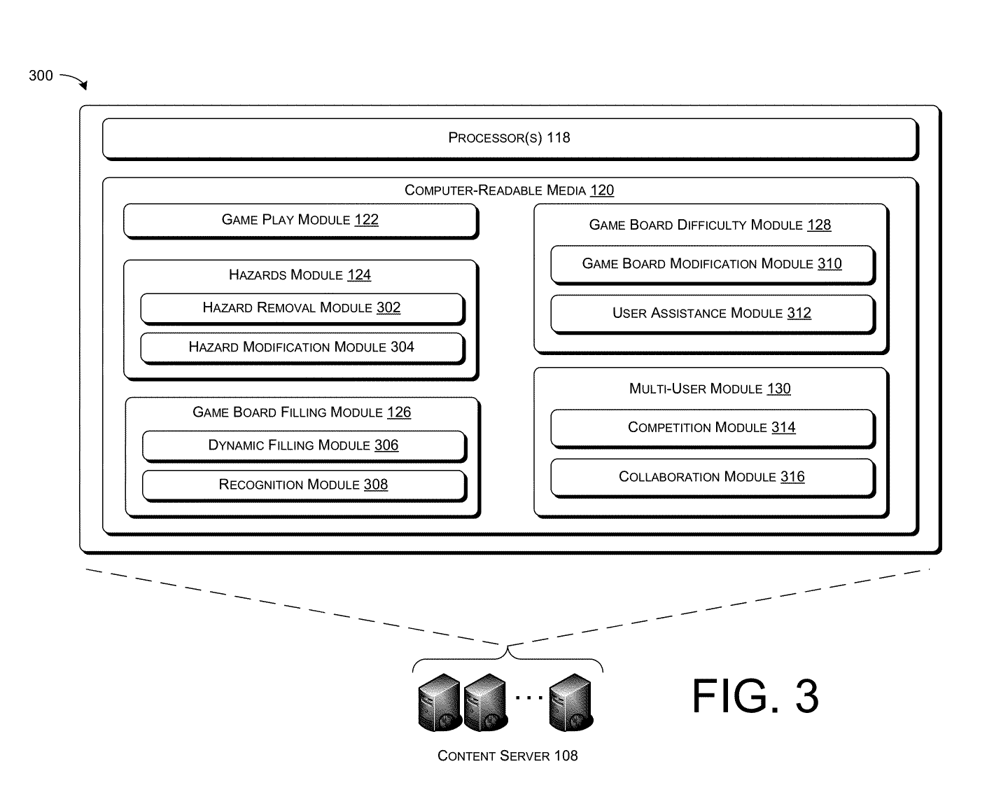

FIG. 3 illustrates an example content server (i.e., content server 108) that may facilitate the play of the games 116 by the users 102. More particularly, the content server 108 may include the one or more processor(s) 118 and the computer-readable media 120, as illustrated in FIG. 1. As shown, the computer-readable media 120 of the content server 108 may store various modules, which will be discussed in greater detail herein.

As noted above, the game play module 122 may allow the users 102 to play the games 116 and to access the game board 202 associated with one of the games 116. The game play module 122 may allow the user 102 to select or match one or more tiles 208 or sets of tiles 208 for the purpose of removing hazards 206 from the game board 202 and to achieve or obtain the objective 204.

In various embodiments, the hazards module 124 may govern the types of hazards 206, which hazards 206 are included on the game board 202, and/or the manner in which the hazards 206 are removed from the game board 202. Moreover, the hazards 206 may obstruct or hinder the user's 102 progress through the game 116 and/or the game board 202, such as by preventing the user 102 from moving down the game board 202 to complete the objective 204, to obtain an object, to remove some or all of the hazards 206, or to complete the game board 202.

As stated above, the matching of tiles 208 on the game board 202 may cause the hazards 206 to be removed from the game board 202. As shown in FIG. 3, a hazard removal module 302 may determine how the hazards 206 are removed from the game board 202. In various embodiments, the non-specific tiles 208 that are in close proximity to a particular hazard 206 may be matched in order to remove that hazard 206. For instance, the user 102 may select one non-specific tile 208, or select or match a set of two or more non-specific tiles 208, in order to remove a hazard 206. The selected tiles 208 may be adjacent to (e.g., to the left/right, above below, diagonal from, etc.) the hazard 206 or may be in the general area of the hazard 206 to be removed. Moreover, in some embodiments, each of the selected tiles 208 has to be in close proximity to the hazard 206 to remove that hazard 206. Alternatively, only one of the selected/matched tiles 208 has to be in close proximity to the hazard 206 in order to remove the hazard 206. If the selected/matched tiles 208 are not in close proximity to a hazard 206, the selected/matched tiles 208 may be removed from the game board 202 without actually removing one of the hazards 206 that is currently residing on the game board 202. The user 102 may then make subsequent selections and matches to remove hazards 206 and/or tiles 208 from the game board 202.

In other embodiments, specific tiles 208 may have to be selected or matched in order to remove a particular hazard 206. That is, to remove a particular hazard 206, a specific tile 208 or set of tiles 208 may have to be selected in order to remove that hazard 206. As a result, matching two identical tiles 208 that are in close proximity to a first hazard 206 may cause the first hazard 206 to be removed, but the matching of those same tiles 208 may not cause a different, second hazard 206 to be removed from the game board 202. As described in additional detail herein, the hazards 206 may be removed from the game board 202 as a result of the user 102 filling the game board 202. For instance, by actuating the fill 210 mechanism, the game board 202 may be filled with additional hazards 206/tiles 208, where at least some of those additional tiles 208 may cause the removal of existing hazards 206 that are included on the game board 202.

With respect to hazards 206 that are removed by the user 102 selecting a particular tile 208 or matching a set of identical tiles 208, the hazard removal module 302 may determine which tiles 208 remove which hazards 206, and may determine which hazards 206/tiles 208 should be included on the game board 202. For the purposes of this discussion, the hazard removal module 302 may create or implement any number of hazards 206/tiles 208 and may determine that certain tiles 208 are to remove certain hazards 206. For instance, the game board 202 may include a single types of hazards 206, or multiple types of hazards 206, such a fire hazard 206, a sand hazard 206, a rock hazard 206, an ice hazard 206, and/or a dragon hazard 206. As stated above, these hazards 206 may include text, graphics, symbols, colors, audio, etc., that represent the particular type of hazard 206. For example, the fire hazard 206 may include an image of a flame and the dragon hazard 206 may include a picture of a dragon.

With respect to the illustrative tiles 208 set forth above, certain tiles 208 may have to be selected or matched to remove those hazards 206. For example, since water is typically used to extinguish a fire, the user 102 may select or match one or more water tiles 208, which may be represented by a water drop, in order to remove the fire hazards 206. Moreover, one or more wind tiles 208 may be selected/matched to remove a sand hazard 206 (e.g., wind may blow sand). In addition, hammer, dynamite or fireworks tiles 208 may be selected/matched to remove a rock tile 208. In certain embodiments, a sun tile 208 or the weight of multiple tiles 208 above an ice hazard 206 may melt or break an ice hazard 206, which may cause the ice hazard 206 to be removed from the game board 202. Further, a tile 208 represented by a samurai warrior or a sword may be selected/matched to remove a dragon hazard 206. In some embodiments, the selection/matching of tiles 208 may not remove a hazard 206 altogether, but may cause the hazard 206 to become weakened or smaller. Using the dragon hazard 206 example, the selection/matching of certain tiles 108 may not remove the dragon hazard 206, but may cause the power of the dragon hazard 206 to be reduced. Moreover, any other image, symbol, text, etc., may be selected for the hazards 206/tiles 208, and the particular image, symbol, text, etc., that is selected may be based on the user's 102 behavior or the extent to which the user 102 has progressed through the game board 202.

In additional embodiments, at least some of the hazards 206 and/or the tiles 208 on the game board 202 may have an appearance that prevents the user 102 from being able to identify the hazards 206 and/or tiles 208. For instance, the hazards 206 and/or tiles 208 may be represented by a question mark (e.g., “?”) or some other visual indication that isn't associated with a particular hazard 206 and/or tile 208. Upon the user 102 selecting that hazard 206/tile 208, selecting a different hazard 206/tile 208, or possibly after a predetermined amount of time, the hazard 206/tile 208 may become identifiable to the user 102 (e.g., a “?” hazard 206 may become a “fire” hazard 206). Moreover, in response to selecting the hazard 206/tile 208, that hazard 206/tile 208 or other hazards 206/tiles 208 may be modified, as discussed below. Although a limited number of hazards 206/tiles 208 have been described above, any number or type of hazards 206/tiles 208 may be included on the game board 202.

Moreover, a hazard modification module 304 of the hazards module 124 may modify or move the hazards 206 that are displayed on the game board 202. The hazards 206 may be modified or moved dynamically while the user 102 is playing the game 116 and possibly in response to one or more actions taken by the user 102 (e.g., selecting tiles 208, removing hazards 206, actuating the fill 210 mechanism to fill the game board 202, other behavior exhibited by the user 102, etc.). The hazards 206 may also be modified or moved based on a lack of action taken by the user 102. For instance, if the user 102 does not select a tile 208 for a predetermined amount of time, one or more hazards 206 may be modified or moved. Alternatively, or in addition, the hazards 206 may be modified at predetermined times while the user 102 is progressing through the game 116 and/or the game board 202.

In certain embodiments, some hazards 206 may be stationary and may only be modified or moved if they are removed as a result of the user 102 selecting and/or matching tiles 208. On the other hand, other hazards 206 may be modified and/or moved around the game board 202 during gameplay. In particular, a particular hazard 206 may be moved around, or spread throughout, the game board 202. For instance, since fire tends to spread if not extinguished, a fire hazard 206 may spread throughout the game board 202 when the fire hazard 206 is not removed by the user 102 in a timely manner. That is, if the user 102 fails to remove the fire hazard 206 by selecting/matching one or more water tiles 208, the fire hazard 206 may move around the game board 202 and/or become larger. Therefore, certain hazards 206 may dynamically move around the game board 202 while the game 116 is being played. In some embodiments, although certain hazards 206 may move, the overall layout of the game board 202 may remain the same, which may cause the game 116 and/or the game board 202 to become more or less difficult as the game 116 is being played.

In addition to hazards 206 possibly moving around the game board 202, the hazards 206 may also change or morph into a different hazard 206 or tile 208. For example, a fire hazard 206 may change into a sand hazard 206, which may cause a change in the type of tiles 208 needed to remove that hazard 206. That is, initially, the selection/matching of water tiles 208 may cause the fire hazard 206 to be removed. However, if the fire hazard 206 changes to a sand hazard 206, one or more wind tiles 208 may need to be selected/matched in order to remove the hazard 206. Moreover, a change from one type of hazard 206 into a different type of hazard 206 may be instantaneous or gradual. For instance, the fire hazard 206 may instantaneously change into the sand hazard 206. On the other hand, a rock hazard 206 may gradually change into a volcano hazard 206, such as by changing into multiple different interstitial states that are neither the initial rock hazard 206 nor the volcano hazard 206. For instance, the rock hazard 206 may appear angrier in each subsequent interstitial state until the rock hazard 206 transitions into the volcano hazard 206.

In other embodiments, a hazard 206 that currently exists on the game board 202 may spawn additional hazards 206 and/or tiles 208. For example, a volcano hazard 206 may spew rock hazards 206 and/or fire hazards 206, which may then occupy a position on the game board 202.

Hazards 206 may also grow or multiply during play of the game 116. For instance, a fire hazard 206 may move or multiply in multiple different directions (like an actual fire), such as by moving up, down, left, right, diagonal, or in any other direction. In contrast, since a bamboo plant tends to grow upwards, a bamboo hazard 206 may grow, extend, multiply, or move in a single direction (i.e., up the game board 202). In addition, and as stated above, a fire hazard 206 may spread throughout the game board 202 if tiles 208 that can remove the fire hazard 206 are not selected or matched.

In further embodiments, certain hazards 206 may consume other hazards 206 or tiles 208 on the game board 202. For example, a dragon hazard 206 may consume eat or consume certain tiles 208 such that the user 102 playing the game 116 may subsequently be unable to match or select various tiles 208. Moreover, additional hazards 206 or tiles 208 may appear throughout the game 116. The additional hazards 206/tiles 208 may include hazards 206/tiles 208 that previously existed on the game board 202 and/or new hazards 206/tiles 208 that are now introduced on the game board 202. As a result, the game board 202 may include a single type of hazards 206/tiles 208 or multiple different types of hazards 206/tiles 208.

In addition to having the hazards 206 be modified, move, grow, multiple, spawn new hazards 206/tiles 208, etc., the hazard modification module 304 may also have the tiles 208 on the game board 202 be modified, move, grow, multiply, span new hazards 206/tiles 208, etc. As a result, as the user 102 is playing the game 116 and progressing through one or more game boards 202 associated with the game 116, the game board 202 may change and as a result become more or less difficult. Accordingly, since the game board 202 may evolve over time, the user 102 may have to adjust his/her strategy during gameplay to effectively play the game 116.

In certain embodiments, the hazard modification module 304 may modify the hazards 206 and/or tiles 208 of the game board 202 based at least in part on one or more predictive models or artificial intelligence. More particularly, the hazard modification module 304 may employ one or more components that plays the game 116 via the game boards 202 in an automated manner. That is, the game boards 202 may be played deterministically to simulate how different users 102 would play the game 116. Such components may play the game board(s) 202 in an automated manner in order to determine how each game board 202 can and should be played. The components may also play the game board(s) 202 based on the hazards 206 and tiles 208 that are currently present on the game board(s) 202, such that the components may play the game board(s) 202 differently based on the actual hazards 206/tiles 208 that are present. This may allow the system 300 to determine how the game 116 and/or the game board(s) 202 may be played with different hazards 206 and/or tiles 208. Based at least in part on data that is collected during such a process, the hazard modification module 304 may determine how various hazards 206 and tiles 208, and modifications thereof, will affect the play of the game 116 and the game board(s) 202.

As described above, the game board filling module 126, and a dynamic filling module 306 in particular, may allow the user 102 to fill the game board 202 based on an action taken by the user 102. In particular, after the user 102 has selected/matched tiles 208, which may cause the removal of the selected/matched tiles 208 and/or the corresponding hazards 206, the dynamic filling module 306 may allow the user 102 to actuate a fill 210 mechanism that causes additional hazards 206 and/or tiles 208 to be introduced onto the game board 202. The introduction of additional hazards 206 and/or tiles 208 may change the layout of the game board 202, and consequently may adjust the difficulty of the game board 202 currently being played.

In various embodiments, the game board 202 may automatically be filled and be populated with additional hazards 206/tiles 208 in response to the user 102 selecting/matching tiles 208 and causing the selected/matched tiles 208 and/or hazards 206 to be removed from the game board 202. Alternatively, the gravity of the game board 202 may be paused until the user 102 performs an action with respect to the game board 202. That is, instead of the game board 202 automatically filling, the user 102 may actuate a fill 210 mechanism at his/her discretion and when the user 102 actually wants the game board 202 to be filled. As a result, no new hazards 206 or tiles 208 may be added to the game board 202 until the user 102 make an indication to do so. Since additional hazards 206/tiles 208 may be added to the game board 202 when the user 102 actuates the fill 210 mechanism, the composition and/or layout of the game board 202 may therefore change.

For the purposes of this discussion, the game board 202 may be filled in any manner. For instance, the additional hazards 206/tiles 208 may be introduced onto the game board 202 from the top, bottom, sides, and/or corners of the game board 202. In particular, the hazards 206/tiles 208 may drop down from the top of the game board 202 and stop when they come into contact with another object, such as the objective 204, an existing hazard 206, an existing tile 208, or one of the additional hazards 206/tiles 208 that has been introduced onto the game board 202. In this embodiment, the additional hazards 206/tiles 208 may appear like they are falling down the game board 202 based on gravity. The game board 202 may also be filled by the additional hazards 206/tiles 208 appearing in the location in which they will be situated on the game board 202. In other embodiments, the game board 202 may be filled from the existing hazards 206/tiles 208, such as by the existing hazards 206/tiles 208 creating the additional hazards 206/tiles 208.

By filling the game board 202, the user 102 may be able to select/match additional tiles 208 that replaced tiles 208 that were previously selected/matched and subsequently removed from the game board 202. With the additional tiles 208, the user 102 may select/match the additional tiles 208 for the purpose of removing more hazards 206 and becoming closer to reaching or achieving the objective 204 and/or completing the game board 202. Accordingly, the user 102 may actuate the fill 210 mechanism to progress further through the game board 202 and the game 116 as a whole. Since the user 102 may be limited in the number of times he/she is allowed to fill the game board 202 (e.g., the remaining fills 212), the user 102 may form a strategy regarding when he/she should fill the game board 202. In some embodiments, the user 102 may obtain additional fills 210 or, when the user's 102 remaining fills 212 have been depleted, the user 102 may obtain additional fills 210, possibly for some type of consideration (e.g., points, currency, etc.).

In additional embodiments, a recognition module 308 of the game board filling module 126 may provide recognition to the user 102 based on the user 102 selecting/matching tiles 208, removing hazards 206/tiles 208 from the game board 202, and/or filling the game board 202. For instance, the user 102 may receive recognition in the form of the score 214, which may be represented by points, currency, tokens, trophies, medals, or anything else that indicates recognition earned by the user 102 while playing the game 116 or a particular game board 202. In certain embodiments, a type of recognition earned by the user 102 may give the user 102 special privileges, enhanced features, etc., with respect to the game 116. The user 102 may receive a certain amount of recognition (e.g., points) when the user 102 selects a tile 208, matches two or more identical tiles 208, and/or removes a hazard 206. The user 102 may also receive recognition when he/she makes combinations of selections/matches, such as the user 102 matching multiple sets of identical tiles 208 consecutively. For instance, if the user 102 matched three sets of matching tiles 208 consecutively, the progress indicator 216 on the game board 202 may indicate that the user 102 has currently made three combinations. The recognition (e.g., number of points) that is earned by the user 102 may increase as the number of combinations increases. For instance, assuming that 10 points are provided for a match of two identical tiles 208, the user 102 may receive 30 total points (as opposed to 20 total points) for a combination of two consecutive matches and may receive 60 total points (as opposed to 30 total points) for a combination of three consecutive matches. As a result, as the number of combinations achieved by the user 102 increases, the recognition earned by the user 102 also increases.

As a result of the user 102 filling the game board 202 when the user 102 has previously obtained a combination of matches, the amount of recognition earned by the user 102 may be multiplied by a particular factor. For instance, the amount of points earned as a result of the combination of tile 208 matches may be doubled, tripled, and so on. Moreover, the extent to which the amount of recognition is increased may be based on the number of combinations achieved. For example, if the user 102 has achieved a combination of two consecutive matches, the amount of recognition may be doubled when the user 102 fills 210 the game board 202. However, if the user 102 has achieved a combination of three consecutive matches, the amount of recognition may be tripled when the user 102 fills 210 the game board 202. As a result, the user 102 has an incentive to wait to fill 210 the game board 202 until a maximum amount, or at least a larger amount, of combinations has been achieved. Then, after the game board 202 is filled, the user 102 has the opportunity to select/match additional sets of tiles 208 and achieve additional combinations.

The recognition module 308 may also cause the recognition earned by the user 102 to be based on time. For instance, the user 102 may receive additional recognition if he/she makes a certain amount of matches in a particular amount of time. Moreover, the game board 202 may fade away or disappear based on the amount of time the user 102 has interacted with the game board 202 and/or the extent of tile 208 matches made by the user 102, which may cause the game board 202 to be more difficult to play and possibly become unplayable. In additional embodiments, the game board 202 may present a time meter that indicates an amount of time the user 102 has remaining to obtain the objective 204, to complete the game board 202, such as by removing all the hazards 206 and/or the tiles 208, and/or to complete the game 116.

With respect to combinations of tile 208 matches, whether or not a combination is made may be based on the amount of time between correct tile 208 matches. For example, multiple consecutive matches of tiles 208 may be considered a combination if there is less than a predetermined amount of time (e.g., three seconds) between the consecutive matches. If the consecutive matches are made within that predetermined amount of time, the consecutive matches may be determined to be a combination, which may be indicated by the progress indicator 216. However, if the amount of time between the consecutive correct matches is greater than that predetermined amount of time, the consecutive matches may not be considered a combination. That is, there may be a time threshold that relates to how soon two different tile 208 matches need to be made with respect to one another in order to be considered a combination. In some embodiments, the game board 202 may include a combination time meter, which may indicate how much time the user 102 has to make consecutive matches and therefore be entitled to a combination of correct tile 208 matches.

As stated above with respect to FIG. 1, the game board difficulty module 128 may adjust the difficulty of the game 116 and/or the game board 202, possibly based on one or more user actions and/or behavior exhibited by a user 102. In particular, a game board modification module 310 may modify the game board 202 for the purpose of adjusting the difficulty of the game board 202.

In various embodiments, the difficulty of the game board 202 may be adjusted (e.g., increased or decreased) by adding or removing hazards 206/tiles 208 to/from the game board 202. For instance, adding hazards 206 to the game board 202 may make it more difficult for the user 102 to progress towards the objective 204 or to complete the game board 202, and vice versa. Moreover, adding tiles 208 to the game board 202 may allow the user 102 to make additional tile 208 matches, remove additional hazards 206, and receive additional recognition as a result. However, in some scenarios, adding tiles 208 to the game board 202 may crowd the game board 202 and make it more difficult for the user 102 to achieve the objective 204 or complete the game board 202. Adding more tiles 208 to the game board 202 may also require the user 102 to make additional matches, which may incur extra time and/or effort. In additional embodiments, additional objectives 204 may be added to the game board 202. If the user 102 need only achieve one of the objectives 204, this may provide the user 102 additional opportunities to complete the game board 202. However, if the user 102 is to achieve each objective 204 on the game board 202, adding more objectives 204 may cause the user 102 to incur additional time in completing the game board 202.

Moreover, the game board modification module 310 may modify the objective(s) 204, hazards 206, and/or tiles 208 currently residing on the game board 202 for the purpose of making the game board 202 more or less difficult. That is, by modifying (e.g., changing, moving, multiplying, etc.) the hazards 206/tiles 208, the game board modification module 310 may make it easier or more difficult to match sets of tiles 208 and remove corresponding hazards 206 from the game board 202. For instance, if a hazard 206 was changed to a different type of hazard 206, and the game board 202 does not presently include any tiles 208 that can remove that hazard 206, the difficulty of removing that hazard 206 and progressing through the game board 202 is likely increased. However, if the hazard 206 was changed to a type of hazard 206 that can be removed by multiple tiles 208 currently residing on the game board 202, the level of difficulty of the game board 202 may have been decreased.

The game board modification module 310 may also adjust the weight or ratio of the hazards 206/tiles 208 present on the game board 202. For instance, and using the example above, if the game board 202 included more fire hazards 206 as compared to sand hazards 206, the game board 202 would be less difficult if it included more water tiles 208 that could be matched to remove the fire hazards 206. On the other hand, if the number of water tiles 208 was low, the level of difficulty of the game board 202 would be higher.

In other embodiments, the game board modification module 310 may adjust the size and/or layout of the game board 202, which may cause the user 102 to have to match more or less tiles 208 to achieve the objective 204 and/or to complete the game board 202. Furthermore, the game board modification module 310 may adjust the extent to which the user 102 is able to fill 210 the game board 202. For example, by increasing the number of remaining fills 212, the user 102 would likely have additional opportunities to match tiles 208 and thus remove hazards 206. However, if the number of remaining fills 212 was decreased, the user 102 may have fewer opportunities to match tiles 208 and remove corresponding hazards 206, which may increase the difficulty of the game board 202.

Moreover, in response to the user 102 initiating a fill 210 of the game board 202, the additional hazards 206/tiles 208 that are introduced onto the game board 202 may remove or eliminate certain hazards 206 or tiles 208. For instance, and as stated above, additional tiles 208 that are located above a particular hazard 206 (e.g., an ice hazard 206), may break the hazard 206 and cause that hazard 206 to be removed. The distance in which the tiles 208 are falling may also determine whether hazards 206 will be removed, and an extent to which multiple hazards 206 may be removed. The presence of new tiles 208 may also cause various hazards 206 to change, move around, multiply, etc., which may affect the difficulty of the game board 202.

In additional embodiments, any modification to the game board 202 may be based on actions taken by the user 102 or the behavior exhibited by the user 102. That is, the game board modification module 310 may adjust the difficulty of the game board 202 based on the user's 102 behavior and/or actions. In certain embodiments, the game board modification module 310 may learn the user's 102 behavior over time and make corresponding changes to the game board 202. Such adjustments may be made dynamically (e.g., in real-time or near real-time) as the game 116 is being played and may be based on how the user 102 is progressing through the game 116 and/or game board 202. For instance, if it is determined that the user 102 is having a difficult time progressing through the game board 202, the game board modification module 310 may remove hazards 206 from the game board 202, modify hazards 206 and/or tiles 208 to increase the ease of making correct tile 208 matches, and/or add tiles 208 that correspond to hazards 206 that currently reside on the game board 202. Such modifications may make it easier for the user 102 to progress through the game board 202. However, if the user 102 progressing through the game board 202 with relative ease, the game board modification module 310 may modify hazards 206, introduce additional hazards 206, remove tiles 208, or reduce the number of remaining fills 212 in order to obstruct or slow down the user's 102 progress. Modification of the game board 202, including dynamic modification of the game board 202, may be performed utilizing an automated or partially-automated mechanism (e.g., one or more algorithms, machine learning techniques, etc.) and/or via a manual mechanism (e.g., by an individual associated with the content server 108 or a service provider).

During play of the game 116, a user assistance module 312 of the game board difficulty module 128 may assist or help the user 102 in progressing through the game board 202. The user assistance module 312 may also assist the user 102 in playing the game 116 after the user 102 is no longer able to fill 210 the game board 202 (i.e., the user 102 has no more remaining fills 212). Typically, when the user 102 is unable to make any additional matches and cannot fill the game board 202, the game 116 may end and/or the user 102 may pay some consideration (e.g., money, points, tokens, etc.) to continue playing the game 116, possibly via the same game board 202 that the user 102 was previously playing.

Alternatively, or in addition, the user assistance module 312 may display additional moves/actions that the user 102 could have, or should have, taken via the game board 202 that would have caused the user 102 to progress further through the game board 202. That is, the user assistance module 312 may display one or more correct tile 208 matches that likely would have allowed the user 102 to become closer to achieving the objective 204 and/or completing the game board 202. Since the user 102 may receive a glimpse of what the user 102 could or should have done with respect to the game board 202, the user 102 may be incentivized to acquire additional fills 210 in order to take those actions (e.g., match those tiles 208). That is, the user 102 may see the previous moves he/she should have made and then make those moves the next time he/she plays the game board 202. In some embodiments, the number of moves (i.e., correct tile 208 matches) may vary, possibly depending upon the user 102 that is playing the game 116. The user assistance module 312 may show one or two tile 208 matches, each tile 208 match to be made to complete the game board 202, or somewhere in between. Moreover, an amount of consideration paid may be based on the number of moves the user 102 would like to view. Then, once the user 102 has no more turns, he/she may again have the option of being presented with moves that would have caused the user 102 to become closer to achieving the objective 204 and/or completing the game board 202.

That is, the user assistance module 312 may provide, to the user 102, one or more guides, tutorials, tips, etc., that are designed to help the user 102 progress through the game board 202. In other embodiments, the user assistance module 312 may perform an auto-play function that selects hazards 206/tiles 208 on behalf of the user 102, or that shows the user 102 which moves the user 102 could have previously made, or which moves the user 102 can subsequently make.

The computer-readable media 120 of the content server 108 also includes the multi-user module 130, which allows multiple users 102 to play the game 116 and/or the game board 202 in a competitive and/or a collaborative manner. In various embodiments, users 102 may earn points 214, additional fills 210, and other consideration by playing the game 116 either competitively against (e.g., beating an opponent) or collaboratively with (e.g., playing the game board 202 with) other users 102.

In various embodiments, a competition module 314 of the multi-user module 130 may allow two or more users 102 to play the game 116 competitively (e.g., head-to-head). For instance, the multiple users 102 may play the same game 116 and/or the same game board 202 against one another, where the users 102 may play the game 116 at the same time or at different times. In these embodiments, the winner of the game 116 may correspond to the user 102 that had the highest score 214, that matched the greatest amount of tiles 208, that removed the greatest amount of hazards 206, that filled the game board 202 the least amount of times, that progressed the furthest through the game board 202 and/or the game 116, and so on. The winner may receive consideration (e.g., points, tokens, additional fills 212, certain privileges, etc.) in exchange for beating the other users 102. As a result, the users 102 may have an incentive to play the game 116 and/or the game board 202 competitively.

During competitive gameplay, the user 102 may take certain actions that affect a user 102 in which he/she is competing against. For instance, the user 102 may share one or more hazards 206 with another user 102, which may cause those hazards 206 to appear on the competitor's game board 202. Since this may make the competitor's game board 202 more challenging, the user 102 may gain an advantage by gifting such hazards 206.

On the other hand, a collaboration module 316 may allow multiple users 102 to play the game 116 and/or the game board 202 in a collaborative manner, such that one or more of the users 102 may strive to achieve a common goal shared by those users 102. In some embodiments, the multiple users 102 may take actions via the game board 202 sequentially, which may be referred to as a relay. For instance, each user 102 may have access to the same game board 202 and may take turns making moves, such as by matching tiles 208 and removing corresponding hazards 206. The relay may be asynchronous so that each of the multiple users 102 may be perceiving the same game board 202 and taking turns. When a user 102 is finished taking his/her turn, one or more of the other users 102 may receive a notification (e.g., via the game board 202, e-mail, text message, etc.) indicating that the user 102 has finished taking his/her turn and that now it is a different user's 102 turn. In other embodiments, multiple users 102 may be playing the game 116 and the game board 202 synchronously, such that the users 102 are playing the same game board 202 at the same time.

During collaborative gameplay, the users 102 playing the game 116 may share or gift various items to one another. For example, the users 102 may share tiles 208 in a collaborative manner, such as by sharing or gifting a tile 208 to a different user 102, which may help that user 102 remove a particular hazard 206. Users 102 may also donate recognition or remaining fills 212 to one another, which may help the users 102 achieve a common goal of achieving the objective 204 and/or completing the game board 202.

### Example Selection/Matching of Tiles

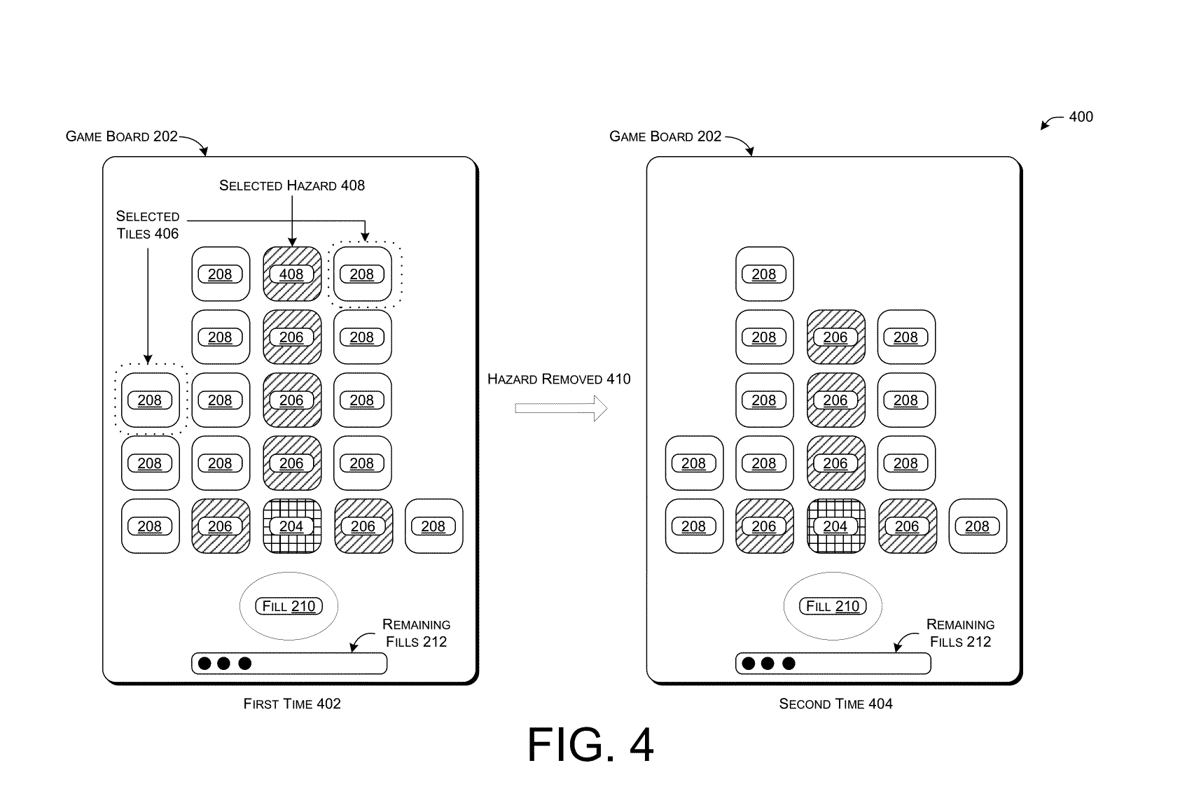

FIG. 4 illustrates an example diagram that shows a selection of tiles 208 via a game board 202 and subsequent removal of one or more hazards 206. As discussed above with respect to FIGS. 1-3, a user 102 may select or match one or more tiles 208 for the purpose of removing one or more hazards 206 from the game board 202. FIG. 4 illustrates the game board 202 at a first time 402 and the game board 202 at a second time 404 that is subsequent to the first time 402. The game board 202 may include one or more objectives 204, one or more hazards 206, one or more tiles 208, a fill 210 mechanism, and remaining fills 212 available to the user 102. Although not shown, the game board 202 may also include the user's 102 score 214, and a progress indicator 216.

As shown in FIG. 4, at the first time 402, the user 102 has selected two different tiles 208, which are represented as selected tiles 406. In various embodiments, in order to make a proper match, the selected tiles 406 have to be of the same type. For instance, a proper match would include selecting two water tiles 208, whereas an improper match would include selecting a water tile 208 and a wind tile 208. If an improper match is made, the user 102 may receive some indication that the tiles 208 do not match, such as a sound, a message/notification, the tiles 208 not being removed from the game board 202, and so on. Here, it is assumed that the selected tiles 406 are of the same type and, therefore, match. However, in some instances, the selected tiles 406 do not need to be of the same type in order for the selected tiles 406 to be removed. For instance, the user 102 may match two different tiles, such as a water tile 208 and a wind tile 208, to remove a particular hazard 206. In other embodiments, matching a water tile 208 and an ice tile 208 may remove weaken a fire hazard 206.

As stated above, by matching tiles 208, the user 102 may cause hazards 206 that are in close proximity to one of the matched tiles 208 to be removed. Here, selected hazard 408 is adjacent to one of the selected tiles 406. In embodiments where any matched tile 208 may cause a hazard 206 to be removed, since one of the selected tiles 406 is adjacent to the selected hazard 408, the selected hazard 408 may be removed from the game board 202. Moreover, in embodiments where a particular tile 208 is needed to remove a particular hazard 206, assuming that the selected tiles 406 are of a type that may cause the selected hazard 408 to be removed, the selected hazard 408 may be removed from the game board 202. For instance, assuming that the selected hazard 408 is a fire hazard 206, and assuming that the selected tiles 406 are water tiles 208, the selected tiles 406 and the selected hazard 408 correspond to one another. Therefore, matching of the selected tiles 406 (i.e., selected water tiles 208) may cause removal of the selected hazard 408 (i.e., selected fire hazard 206).

Upon matching the selected tiles 406, the selected hazard 408 may be removed from the game board 202 (i.e., hazard removed 410). In addition, matching of the selected tiles 406 may also cause the selected tiles 406 to be removed from the game board 202. As shown on the game board 202 at the second time 404, the game board 202 includes the previously existing hazards 206 and tiles 208 with the selected tiles 406 and the selected hazard 408 being removed. At this point, the user 102 may continue to select and/or match tiles 208, which may cause the removal of additional hazards 206 from the game board 202. The user 102 may also fill 210 the game board 202 with additional hazards 206 and/or tiles 208, assuming that the user 102 has at least one remaining fill 212, which is the case at the second time 404.

### Example Filling of the Game Board

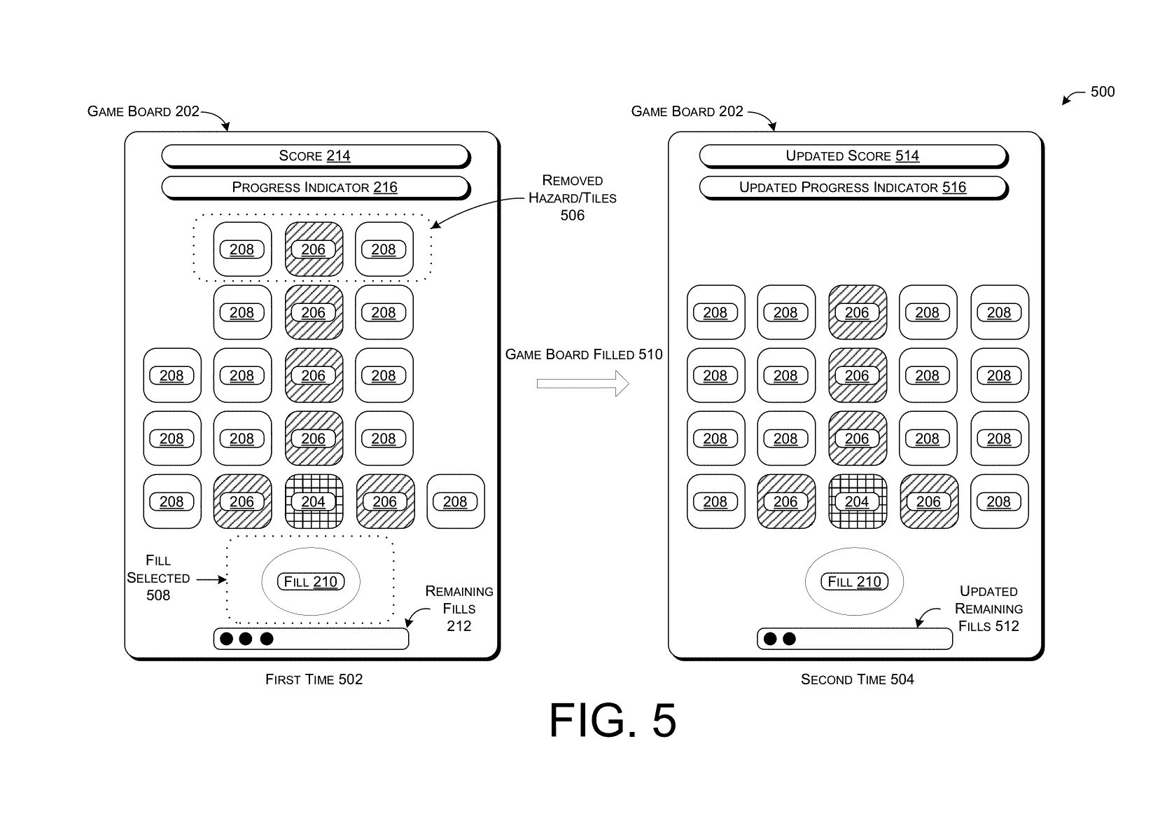

FIG. 5 illustrates an example diagram that shows the filling of a game board 202. As discussed above with respect to FIGS. 1-3, a user 102 may initiate filling of the game board 202 at his/her discretion, which may cause additional hazards 206 and/or tiles 208 be introduced to the game board 202. FIG. 5 illustrates the game board 202 at a first time 502 and the game board 202 at a second time 504 that is subsequent to the first time 502. The game board 202 at the first time 502 may include one or more objectives 204, one or more hazards 206, one or more tiles 208, a fill 210 mechanism, remaining fills 212 available to the user 102, the user's 102 score 214, and a progress indicator 216.

Initially, for the purpose of FIG. 5, assume that the user 102 previously selected/matched two tiles 208 at or prior to the first time 502, which caused the removal of a hazard 206 and the selected/matched tiles 208, which are represented by removed hazard/tiles 506. Subsequently, for strategic or other reasons, the user 102 may elect to fill 210 the game board 202, thereby causing additional hazards 206 and/or tiles 208 to be introduced to the game board 202. To do so, the user 102 may select the fill 210 mechanism, which is represented by fill selected 508. In response to the user 102 filling the game board 202, the game board 202 may be filled (game board filled 510).

FIG. 5 illustrates the game board 202 at the second time 504 without the removed hazard/tiles 506 and after the user 102 selected the fill 210 mechanism. As shown, the game board 202 has been filled with additional tiles 208 to replace locations where no tiles 208 existed at the first time 502. The user 102 may then have the ability to select/match additional tiles 208 for the purpose of removing additional hazards 206 from the game board 202. In addition, prior to the user 102 filling the game board 202 at the first time 502, FIG. 5 shows that the user 102 had three remaining fills 212. However, after the user 102 selected the fill 210 mechanism, the number of remaining fills 212 decreased by one. As shown, the game board 202 at the second time 504 shows that the user 102 now has two remaining fills 212, which is represented by updated remaining fills 512.

The user 102 may also have received consideration (e.g., points, currency, tokens, privileges, etc.) for matching the tiles 208, removing the hazards 206 and/or tiles 208 (i.e., removed hazard/tiles 506), and/or filling the game board 202 (i.e., game board filled 510). As a result, the game board 202 at the second time 504 illustrates an updated score 514 for the user 102 and an updated progress indicator 516, which may indicate an extent to which the user 102 has currently progressed through the game 116 and/or the game board 202, any combinations the user 102 may have earned, and so on.

### Example Processes

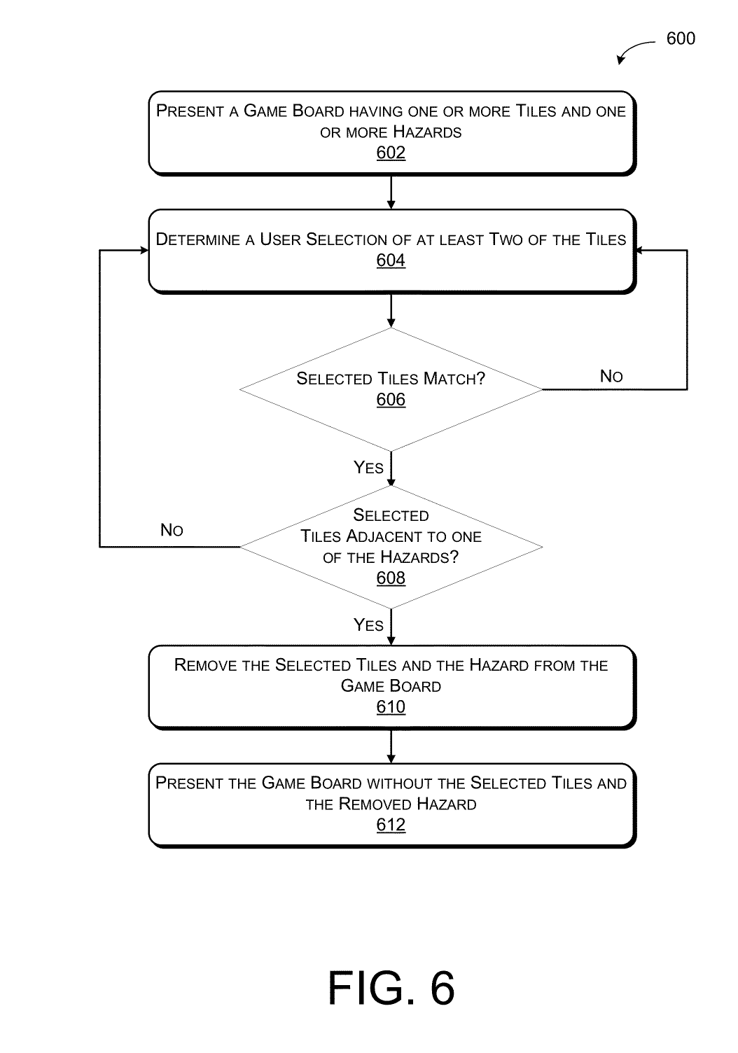

FIGS. 6-9 describe various example processes of facilitating play of a game via a game board. The example processes are described in the context of the environment of FIGS. 1-5 but are not limited to those environments. The order in which the operations are described in each example method is not intended to be construed as a limitation, and any number of the described blocks can be combined in any order and/or in parallel to implement each method. Moreover, the blocks in FIGS. 6-9 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 6 is a flow diagram illustrating an example process 600 of user-initiated removal of hazards and/or tiles via a game board of a game. Moreover, the following actions described with respect to FIG. 6 may be performed by a server, a service provider, a merchant, and/or the content server(s) 108, as shown in FIG. 1.

Block 602 illustrates presenting a game board having one or more tiles and one or more hazards. In various embodiments, a user 102 may play a game 116 via a game board 202 that is presented via a user device 104 associated with the user 102. The game board 202 may include one or more objectives 204, one or more hazards 206, one or more selectable tiles 208, and a fill 210 mechanism that may be actuated by the user 102.

Block 604 illustrates determining a user selection of at least two of the tiles. More particularly, it may be determined that the user 102 has selected at least two of the tiles 208 via the game board 202. The user 102 may select particular tiles 208 for the purpose of removing hazards 206 from the game board 202.

Block 606 determines whether the selected tiles match. In response to the user 102 selecting at least two tiles 208, the content server 108 may determine whether the selected tiles 208 match. In other embodiments, an application associated with a user device 104, or code running on the user device 104, may determine whether the selected tiles 208 match. More particularly, the tiles 208 may be of different types so it may be determined whether the tiles 208 are the same type. In certain embodiments, instead of the tiles 208 needing to match, the at least two tiles 208 need only relate or correspond to one another. For example, although a water tile 208 and an ice tile 208 may not match, they may be related to a sufficient degree so that the at least two tiles 208 may be considered a match. If the at least two tiles 208 do not match, or at least correspond or relate to one another (the “No” arrow from block 606), the process 600 may end and the content server 108 may determine if additional tiles 208 are selected by the user 102. However, in some embodiments, particular hazards 206 may be removed even if two selected tiles 208 do not match. Here, the two selected tiles 208 may correspond or relate to one another, or be entirely different.

Block 608 determines whether the selected tiles are adjacent to one of the hazards. If it is determined that the selected tiles 208 match (the “Yes” arrow from block 606), the content server 108 may determine whether at least one of the matched tiles 208 is in close proximity to (e.g., above, below, to the left/right, diagonal to, etc.) a hazard 206. If not (the “No” arrow from block 608), the process 600 may end and the content server 108 may determine if additional tiles 208 are selected by the user 102. Pursuant to the “No” arrow from block 608, the two selected tiles 208 may be removed, but not the hazard 206.

Block 610 illustrates removing the selected tiles and the hazard from the game board. If it is determined that the selected tiles 208 are adjacent to, or are in close proximity to, one of the hazards 206 (the “Yes” arrow from block 608), that hazard 206 and the selected matching tiles 208 may be removed from the game board 202. As a result, one of the hazards 206 that was potentially obstructing the user's 102 progress through the game board 202 may be removed, which may cause the user 102 to become closer to achieving the objective 204 and/or completing the game board 202. In other embodiments, if it is determined that the selected tiles 208 are in close proximity to one of the hazards 206, the selected tiles 208 may be removed and the hazard 206 may be weakened or reduced. Then, the weakened/reduced hazard 206 may be further weakened/reduced or even removed in response to the subsequent matching of tiles 208 in proximity to that hazard 206.

Block 612 illustrates presenting the game board without the selected tiles and the removed hazard. More particularly, after the matching selected tiles 208 and the hazard 206 has been removed from the game board 202, the user 102 may view an updated version of the game board 202. The user 102 may then continue to select tiles 208 for the purpose of removing additional hazards 206.

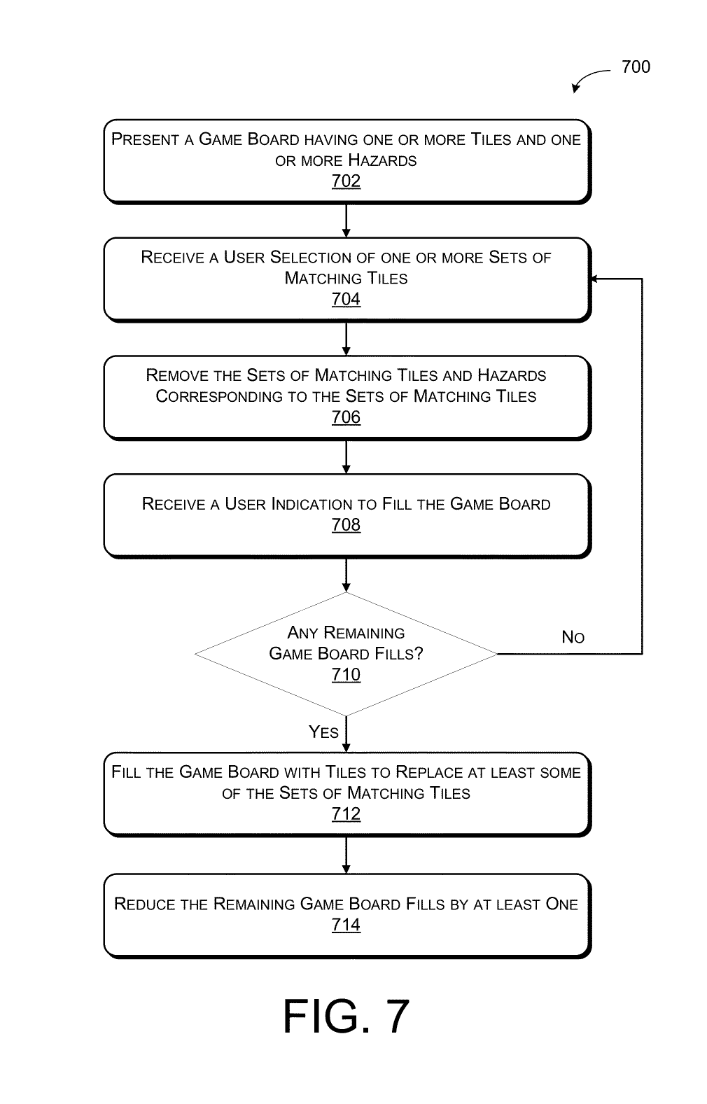

FIG. 7 is a flow diagram illustrating an example process 700 of user-initiated filling of a game board associated with a game. Moreover, the following actions described with respect to FIG. 7 may be performed by a server, a service provider, a merchant, and/or the content server(s) 108, as shown in FIG. 1.

Block 702 illustrates presenting a game board having one or more tiles and one or more hazards. In various embodiments, a user 102 may play a game 116 via a game board 202 that is presented via a user device 104 associated with the user 102. The game board 202 may include one or more objectives 204, one or more hazards 206, one or more selectable tiles 208, a fill 210 mechanism that may be actuated by the user 102, and an amount of remaining fills 212.

Block 704 illustrates receiving a user selection of one or more sets of matching tiles. In various embodiments, the content server 108 may determine that the user 102 has selected a set of two or more matching tiles 208 (e.g., two water tiles 208, two wind tiles 208, etc.).

Block 706 illustrates removing the sets of matching tiles and hazards corresponding to the sets of matching tiles. Provided that at least one of the matching tiles 208 may remove a hazard 206 that is in close proximity to the at least one matching tile 208, the hazard 206 and the sets of matching tiles 208 may be removed from the game board 202.

Block 708 illustrates receiving a user indication to fill the game board. As hazards 206 and/or tiles 208 are removed from the game board 202, the user 102 may want to replace those hazards 206/tiles 208 with additional hazards 206/tiles 208. As a result, the user 102 may actuate the fill 210 mechanism, which may cause additional hazards 206/tiles 208 to be introduced onto the game board 202.

Block 710 determines whether there are any remaining game board fills. In some embodiments, after receiving the indication that the user 102 wishes to fill the game board 202, and before actually filling the game board 202, the content server 108 may determine whether the user 102 has any remaining fills 212 to fill the game board 202. In some instances, the number of times in which the user 102 may fill the game board 202 may be limited. If the user 102 does not have any remaining fills 212 (the “No” arrow from block 710), the user 102 may not be allowed to fill the game board 202 and may have the option to either acquire additional fills 210 or select/match additional tiles 208.

Block 712 illustrates filling the game board with tiles to replace at least some of the sets of matching tiles. If it is determined that the user 102 does have at least one remaining fill 212 (the “Yes” arrow from block 710), the content server 108 may fill the game board 202 with additional hazards 206 and/or tiles 208. As a result, the game board 202 may now include additional tiles 208 that the user 102 may select in order to remove additional hazards 206.

Block 714 illustrates reducing the remaining game board fills by at least one. In response to filling the game board 202, the content server 108 may reduce the number of remaining fills 212 to account for the fill 210 that was previously actuated by the user 102 and executed by the content server 108. As stated above, the user 102 may obtain additional fills 212 in response to reaching an achievement (e.g., achieving the objective 204, completing a game board 202, removing a particular number of hazards 206 or tiles 208, achieving a particular score 214, etc.) or buying the fills 212.

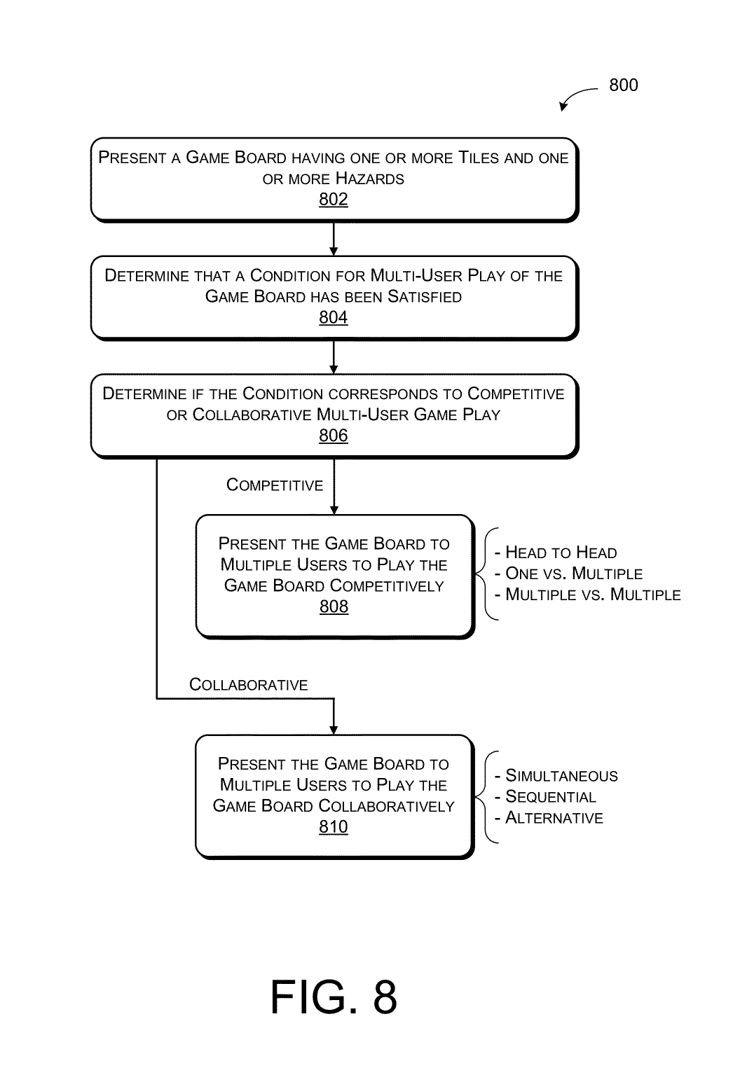

FIG. 8 is a flow diagram illustrating an example process 800 of facilitating gameplay via a game board for multiple users. Moreover, the following actions described with respect to FIG. 8 may be performed by a server, a service provider, a merchant, and/or the content server(s) 108, as shown in FIG. 1.

Block 802 illustrates presenting a game board having one or more tiles and one or more hazards. In various embodiments, a user 102 may play a game 116 via a game board 202 that is presented via a user device 104 associated with the user 102. The game board 202 may include one or more objectives 204, one or more hazards 206, one or more selectable tiles 208, a fill 210 mechanism that may be actuated by the user 102, and an amount of remaining fills 212.

Block 804 illustrates determining that a condition for multi-user play of the game board has been satisfied. In various embodiments, the content server 108 may determine whether multiple users 102 would like to play the game 116, either competitively or collaboratively. In some instances, the users 102 may express such an indication. In other embodiments, one or more users 102 may select two or more tiles 208, achieve an objective 204, remove a hazard 206, complete the game board 202, or perform any other action with respect to the game 116 or the game board 202 that satisfies a condition to trigger multi-user gameplay.

Block 806 illustrates determining if the condition corresponds to competitive or collaborative multi-user game play. In various embodiments, the content server 108 may determine whether the users 108 would like to play the game 116 competitively against other users 102 or collaboratively with other users 102.

Block 808 illustrates presenting the game board to multiple users to play the game board competitively. In the event that the users 102 would like to play the game competitively (the “Competitive” arrow from block 806), the users 108 may play the game 116 via the game board 202 in a competitive manner. For instance, two different users 102 may play against one another in a head-to-head format, where one of the two users 102 will emerge as the winner of the game 116. In other embodiments, one user 102 may play against multiple users 102 or multiple users 102 may play against multiple users 102. Moreover, the users 102 may play the game 116 via the game board 202 synchronously or asynchronously.

Block 810 illustrates presenting the game board to multiple users to play the game board collaboratively. Alternatively, the users 102 may play the game 116 in a collaborative manner while having a common goal that is shared amongst the users 102 (the “Collaborative” arrow from block 806). The common goal may correspond to matching tiles 208, removing hazards 206, achieving the objective 204, completing the game board 202, completing the game 116, achieving a certain score 214, and so on. In these embodiments, the users 102 may play the same, or a different, game board 202 simultaneously in a synchronous manner. In other embodiments, the users 102 may play the game 116 asynchronously, such as by performing actions with respect to the game board 202 sequentially or by alternating (e.g., sharing fills 212 or tiles 208).

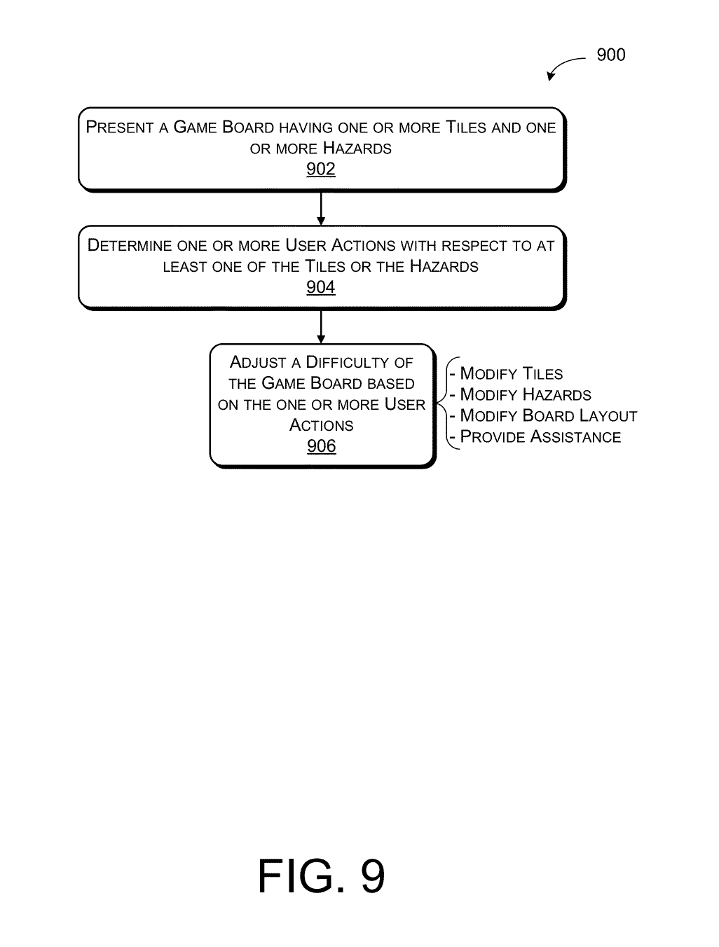

FIG. 9 is a flow diagram illustrating an example process 900 of adjusting the difficulty of a game board associated with a game. Moreover, the following actions described with respect to FIG. 9 may be performed by a server, a service provider, a merchant, and/or the content server(s) 108, as shown in FIG. 1.

Block 902 illustrates presenting a game board having one or more tiles and one or more hazards. In various embodiments, a user 102 may play a game 116 via a game board 202 that is presented via a user device 104 associated with the user 102. The game board 202 may include one or more objectives 204, one or more hazards 206, one or more selectable tiles 208, a fill 210 mechanism that may be actuated by the user 102, and an amount of remaining fills 212.

Block 904 illustrates determining one or more user actions with respect to at least one of the tiles or the hazards. In various embodiments, the users 102 may match tiles 208, remove hazards 206, and otherwise progress through the game board 202 at varying rates. The users 102 may also perform other actions with respect to the game board 202. In some embodiments, the user actions(s) may correspond to general or specific behavior exhibited by the user 102.

Block 906 illustrates adjusting a difficulty of the game board based on the one or more user actions. Based on the user actions, the content server 108 may adjust the difficulty of the game board 202, such as by modifying tiles 208 and/or hazards 206, modifying a layout of the game board 202, providing assistance to the users 102, modifying the number of fills 210 available to the user 102, and so on. In some embodiments, the user actions may indicate whether the users 102 are progressing through the game board 202 with relative difficulty or ease. In response to this determination, the content server 108 may increase the difficulty of the game board 202 for those users 102 that are having a relatively easy time playing the game board 202, while decreasing the difficulty of the game board 202 for those users 102 that are having a more difficult time progressing through the game board 202.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
memory;
one or more processors; and
a game stored in the memory and that is executable by the one or more processors to present a game board via a user interface, the game board including:
a first hazard of a first type;
a second hazard of a second type;
a first set of tiles that corresponds to the first hazard, a user selection of two or more tiles of the first set of tiles causing a removal of the first hazard from the game board in response to determining that at least one tile of the two or more tiles of the first set of tiles are in proximity to the first hazard; and
a second set of tiles that corresponds to the second hazard, a user selection of two or more tiles of the second set of tiles causing a removal of the second hazard from the game board in response to determining that at least one tile of the two or more tiles of the second set of tiles is in proximity to the second hazard.

2. The system as recited in claim 1, wherein at least one of the first hazard or the second hazard obstructs or hinders a user's progress through the game board.

3. The system as recited in claim 1, wherein:
a selection of two or more tiles of the first set of tiles in proximity to the second hazard does not cause the removal of the second hazard; and
a selection of two or more tiles of the second set of tiles in proximity to the first hazard does not cause a removal of the first hazard.

4. The system as recited in claim 1, wherein an appearance of the first set of tiles indicates that the first set of tiles are to be selected to remove the first hazard from the game board, and wherein an appearance of the second set of tiles indicates that the second set of tiles are to be selected to remove the second hazard from the game board.

5. The system as recited in claim 1, wherein the game board includes one or more objectives that are reached or completed by removing at least the first hazard or the second hazard from the game board.

6. The system as recited in claim 1, wherein the game board further includes:
a fill mechanism that, upon actuation by a user, causes the game board to be filled with at least one of one or more additional tiles or one or more additional hazards; and
a remaining fills indicator that indicates a number of times the user is authorized to fill the game board.

7. A method comprising:
presenting, by one or more computing devices, a game board associated with a game, the game board including one or more hazards and a plurality of tiles;
detecting a user selection of at least two tiles of the plurality of tiles;
determining whether the at least two tiles correspond or relate to one another;
in response to determining that the at least two tiles correspond or relate to one another, determining whether a tile of the at least two tiles is adjacent to a hazard of the one or more hazards;
in response to determining that the tile is adjacent to the hazard, determining that a type of the tile corresponds to a type of the hazard; and
in response to determining that the type of the tile corresponds to the type of the hazard, removing the hazard from the game board.

8. The method as recited in claim 7, further comprising, in response to determining that the at least two tiles correspond or relate to one another, removing the at least two tiles from the game board.

9. The method as recited in claim 7, wherein determining that the type of the tile corresponds to the type of the hazard includes determining that a selection of the tile is to cause the hazard to be removed from the game board.

10. The method as recited in claim 7, further comprising determining that the tile is adjacent to the hazard by determining that the tile is at least one of above, below, to the side of, or diagonal to the hazard.

11. The method as recited in claim 7, further comprising dynamically modifying a difficulty of the game board based on at least one of an action performed by a user playing the game, a behavior exhibited by the user, an extent to which the user has progressed through the game or the game board, or inaction by the user.

12. A method comprising:
presenting, by one or more computing devices, a game board associated with a game, the game board including one or more hazards and a plurality of tiles, at least two related tiles of the plurality of tiles, when selected, causing removal of a hazard of the one or more hazards; and
adjusting a difficulty of the game board by dynamically modifying at least one of a hazard of the one or more hazards or a tile of the plurality of tiles.

13. The method as recited in claim 12, wherein the difficulty of the game board is adjusted by dynamically modifying the hazard or the tile based at least partly on an action performed by a user with respect to the game board.

14. The method as recited in claim 12, wherein the difficulty of the game board is adjusted by dynamically modifying the hazard or the tile based at least partly on a behavior exhibited by a user that is accessing the game board.

15. The method as recited in claim 12, wherein the difficulty of the game board is adjusted by dynamically modifying the hazard or the tile based at least partly on inaction of a user with respect to the game board.

16. The method as recited in claim 12, wherein:
the hazard is dynamically modified by moving the hazard from a first location on the game board to a second location on the game board; or
the tile is dynamically modified by moving the tile from a first location on the game board to a second location on the game board.

17. The method as recited in claim 12, wherein:
the hazard is of a first type of hazard, and wherein the hazard is dynamically modified by changing the hazard from the first type of hazard to a different, second type of hazard; or
the tile is of a first type of tile, and wherein the tile is dynamically modified by changing the tile from the first type of tile to a different, second type of tile.

18. The method as recited in claim 12, wherein:
the hazard is dynamically modified by causing the hazard to multiply on the game board or spawn one or more additional hazards; or
the tile is dynamically modified by causing the tile to multiply on the game board or spawn one or more additional tiles.

19. The method as recited in claim 12, wherein the difficulty of the game board is adjusted by at least one of adding additional hazards to the game board, removing at least some of the one or more hazards from the game board, adding additional tiles to the game board, or removing at least some of the plurality of tiles from the game board.

20. The method as recited in claim 12, wherein:
the hazard is dynamically modified by at least one of causing the hazard to grow or extend on the game board or causing the hazard to consume other hazards or at least some of the plurality of tiles; or
the tile is dynamically modified by at least one of causing the tile to grow or extend on the game board or causing the tile to consume other hazards or at least some of the plurality of tiles.
